(19) United States
(12) Patent Application Publication
(10) Pub. No.: US 2024/0045890 A1
(43) Pub. Date: Feb. 8, 2024

(54) SCALABLE ENTITY MATCHING WITH FILTERING USING LEARNED EMBEDDINGS AND APPROXIMATE NEAREST NEIGHBOURHOOD SEARCH

(71) Applicant: SAP SE, Walldorf (DE)

(72) Inventors: Hoang-Vu Nguyen, Leimen (DE); Li Rong Wang, SINGAPORE (SG); Matthias Frank, Heidelberg (DE); Rajesh Vellore Arumugam, SINGAPORE (SG); Stefan Klaus Baur, Heidelberg (DE); Sundeep Gullapudi, SINGAPORE (SG)

(21) Appl. No.: 17/817,388

(22) Filed: Aug. 4, 2022

(51) Int. Cl. G06F 16/28; G06N 20/00; G06F 16/2457; G06K 9/62

(52) U.S. Cl. CPC G06F 16/288; G06N 20/00; G06F 16/24578; G06K 9/6215

(57) ABSTRACT

Methods, systems, and computer-readable storage media for a machine learning (ML) system for matching a query entity to one or more target entities, the ML system that reducing a number of query-target entity pairs from consideration as potential matches during inference.

### BACKGROUND

Enterprises continuously seek to improve and gain efficiencies in their operations. To this end, enterprises employ software systems to support execution of operations. Recently, enterprises have embarked on the journey of so-called intelligent enterprise, which includes automating tasks executed in support of enterprise operations using machine learning (ML) systems. For example, one or more ML models are each trained to perform some task based on training data. Trained ML models are deployed, each receiving input (e.g., a computer-readable document) and providing output (e.g., classification of the computer-readable document) in execution of a task (e.g., document classification task). ML systems can be used in a variety of problem spaces. An example problem space includes autonomous systems that are tasked with matching items of one entity to items of another entity. Examples include, without limitation, matching questions to answers, people to products, bank statements to invoices, and bank statements to customer accounts.

### SUMMARY

Implementations of the present disclosure are directed to a machine learning (ML) system for matching a query entity to one or more target entities. More particularly, implementations of the present disclosure are directed to a ML system that reduces a number of target entities from consideration as potential matches to a query entity using learned embeddings.

In some implementations, actions include receiving historical data including a set of ground truth query-target entity pairs, determining a filtering threshold based on similarity scores of a validation set of ground truth query-target entity pairs of the historical data, the validation set of ground truth query-target entity pairs being a sub-set of the set of ground truth query-target entity pairs of the historical data, receiving inference data comprising a set of query entities and a set of target entities, each query entity in the set of query entities to be matched to one or more target entities of the set of target entities, providing, by an embedding module, a set of query entity embeddings and a set of target entity embeddings, defining a set of query-target entity pairs, each query-target entity pair including a query entity of the set of query entities and a target entity of the set of target entities, for each query-target entity pair in the set of query-target entity pairs, determining a similarity score, filtering query-target entity pairs from the set of query-target entity pairs based on respective similarity scores to provide a set of filtered query-target entity pairs, the set of filtered query-target entity pairs having fewer query-target entity pairs than the set of query-target entity pairs, and executing, by a ML model, inference on each filtered query-target entity pair in the set of filtered query-target entity pairs, during inference, the ML model assigning a label to each filtered query-target entity pair. Other implementations of this aspect include corresponding systems, apparatus, and computer programs, configured to perform the actions of the methods, encoded on computer storage devices.

These and other implementations can each optionally include one or more of the following features: determining the filtering threshold includes determining a similarity score between a query entity and a target entity of respective ground truth query-target entity pairs, determining a minimum similarity score for each unique query entity in the validation set of ground truth query-target entity pairs to provide a set of minimum similarity scores, sorting minimum similarity scores in descending order, and selecting the filtering threshold as a minimum similarity score in the set of similarity score based on a target recall score; the embedding model and the ML model are trained using a training set of the historical data; each ground truth query-target entity pair in the set of ground truth query-target entity pairs is assigned with a label indicating a type of match between a query entity and a target entity of the respective ground truth query-target entity pair; the label indicates a type of match for respective filtered query-target entity pairs; actions further include storing the set of filtered query-target entity pairs in a file structure having a set of dictionaries, each dictionary recording a respective sub-set of filtered query-target entity pairs as a batch, and during inference, reading filtered query-target entity pairs from the file structure for processing by the ML model; and the file structure further has a query key to index map that maps each query entity to a sub-set of filtered query-target entity pairs, and a target index to key map that maps indices of target entities determined from the sub-sets of filtered query-target entity pairs to respective target keys.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts portions of example electronic documents.

FIG. 4 depicts example similarity threshold determination in accordance with implementations of the present disclosure.

FIG. 5 depicts an example file structure for storage and retrieval of filtered query-target entity pairs (index pairs) in accordance with implementations of the present disclosure.

FIG. 6 depicts an example conceptual architecture in accordance with implementations of the present disclosure.

FIG. 7 depicts an example process that can be executed in accordance with implementations of the present disclosure.

FIG. 8 is a schematic illustration of example computer systems that can be used to execute implementations of the present disclosure.

Like reference symbols in the various drawings indicate like elements.

### DETAILED DESCRIPTION

Implementations of the present disclosure are directed to a machine learning (ML) system for matching a query entity to one or more target entities. More particularly, implementations of the present disclosure are directed to a ML system that reduces a number of target entities from consideration as potential matches to a query entity using learned embeddings.

Implementations can include actions of receiving historical data including a set of ground truth query-target entity pairs, determining a filtering threshold based on similarity scores of a validation set of ground truth query-target entity pairs of the historical data, the validation set of ground truth query-target entity pairs being a sub-set of the set of ground truth query-target entity pairs of the historical data, receiving inference data comprising a set of query entities and a set of target entities, each query entity in the set of query entities to be matched to one or more target entities of the set of target entities, providing, by an embedding module, a set of query entity embeddings and a set of target entity embeddings, defining a set of query-target entity pairs, each query-target entity pair including a query entity of the set of query entities and a target entity of the set of target entities, for each query-target entity pair in the set of query-target entity pairs, determining a similarity score, filtering query-target entity pairs from the set of query-target entity pairs based on respective similarity scores to provide a set of filtered query-target entity pairs, the set of filtered query-target entity pairs having fewer query-target entity pairs than the set of query-target entity pairs, and executing, by a ML model, inference on each filtered query-target entity pair in the set of filtered query-target entity pairs, during inference, the ML model assigning a label to each filtered query-target entity pair.

Implementations of the present disclosure are described in further detail with reference to an example problem space that includes the domain of finance and matching bank statements to invoices. More particularly, implementations of the present disclosure are described with reference to the problem of, given a bank statement (e.g., a computer-readable electronic document recording data representative of a bank statement), enabling an autonomous system using a ML model to determine one or more invoices (e.g., computer-readable electronic documents recording data representative of one or more invoices) that are represented in the bank statement. It is contemplated, however, that implementations of the present disclosure can be realized in any appropriate problem space.

Implementations of the present disclosure are also described in further detail herein with reference to an example application that leverages one or more ML models to provide functionality (referred to herein as a ML application). The example application includes SAP Cash Application (CashApp) provided by SAP SE of Walldorf, Germany. CashApp leverages ML models that are trained using a ML framework (e.g., SAP AI Core) to learn accounting activities and to capture rich detail of customer and country-specific behavior. An example accounting activity can include matching payments indicated in a bank statement to invoices for clearing of the invoices. For example, using an enterprise platform (e.g., SAP S/4 HANA), incoming payment information (e.g., recorded in computer-readable bank statements) and open invoice information are passed to a matching engine, and, during inference, one or more ML models predict matches between records of a bank statement and invoices. In some examples, matched invoices are either automatically cleared (auto-clearing) or suggested for review by a user (e.g., accounts receivable). Although CashApp is referred to herein for purposes of illustrating implementations of the present disclosure, it is contemplated that implementations of the present disclosure can be realized with any appropriate application that leverages one or more ML models.

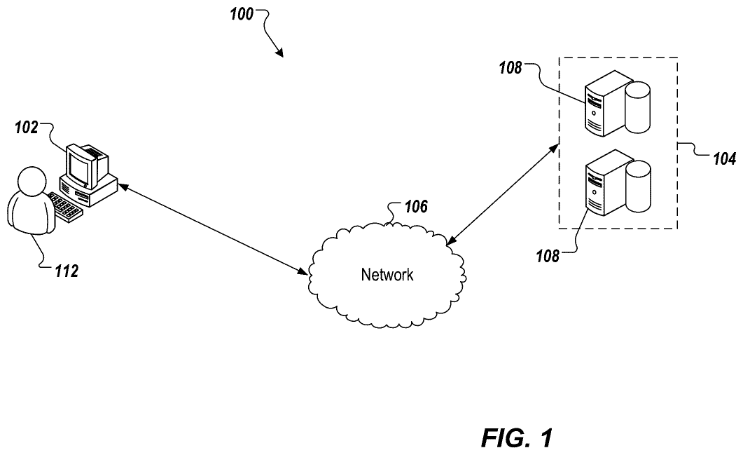

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host an autonomous system that uses a ML model to match entities. That is, the server system 104 can receive computer-readable electronic documents (e.g., bank statement, invoice table), and can match entities within the electronic document (e.g., a bank statement) to one or more entities in another electronic document (e.g., invoice table). In some examples, the server system 104 includes a ML platform that provides and trains a ML model, as described herein.

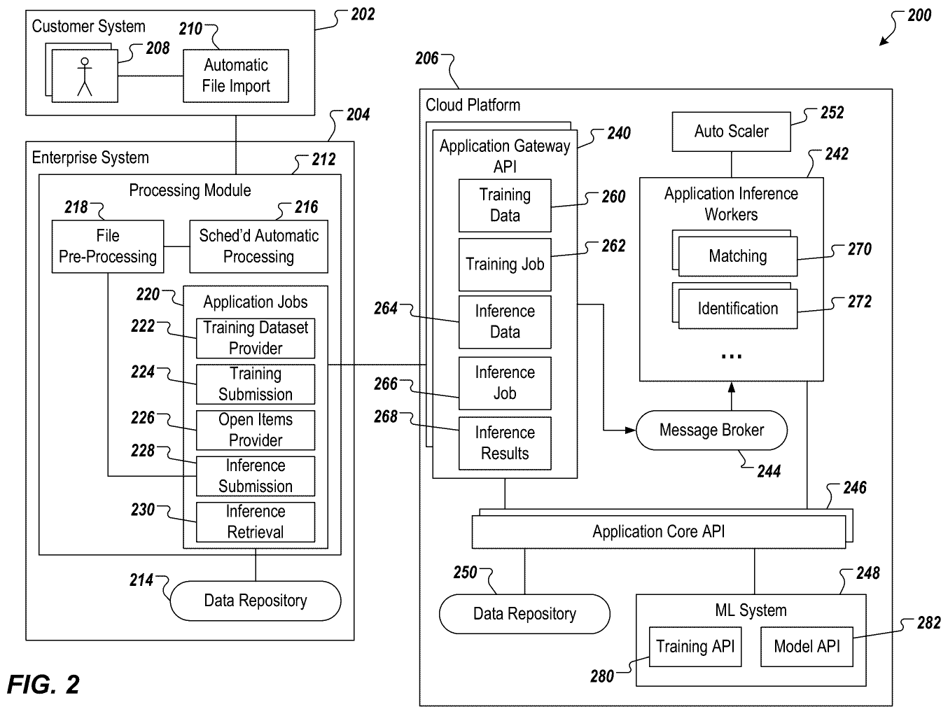

FIG. 2 depicts an example conceptual architecture 200 in accordance with implementations of the present disclosure. In the depicted example, the conceptual architecture 200 includes a customer system 202, an enterprise platform 204 (e.g., SAP S/4 HANA) and a cloud platform 206 (e.g., SAP Cloud Platform (Cloud Foundry)). As described in further detail herein, the enterprise platform 204 and the cloud platform 206 facilitate one or more ML applications that leverage ML models to provide functionality for one or more enterprises. In some examples, each enterprise interacts with the ML application(s) through a respective customer system 202. For purposes of illustration, and without limitation, the conceptual architecture 200 is discussed in further detail with reference to CashApp, introduced above. However, implementations of the present disclosure can be realized with any appropriate ML application.

In the example of FIG. 2, the customer system 202 includes one or more client devices 208 and a file import module 210. In some examples, a user (e.g., an employee of the customer) interacts with a client device 208 to import one or more data files to the enterprise platform 204 for processing by a ML application. For example, and in the context of CashApp, an invoice data file and a bank statement data file can be imported to the enterprise platform 204 from the customer system 202. In some examples, the invoice data file includes data representative of one or more invoices issued by the customer, and the bank statement data file includes data representative of one or more payments received by the customer. As another example, the one or more data files can include training data files that provide customer-specific training data for training of one or more ML models for the customer.

In the example of FIG. 2, the enterprise platform 204 includes a processing module 212 and a data repository 214. In the context of CashApp, the processing module 212 can include a finance—accounts receivable module. The processing module 212 includes a scheduled automatic processing module 216, a file pre-processing module 218, and an applications job module 220. In some examples, the scheduled automatic processing module 216 receives data files from the customer system 202 and schedules the data files for processing in one or more application jobs. The data files are pre-processed by the file pre-processing module 218 for consumption by the processing module 212.

Example application jobs can include, without limitation, training jobs and inference jobs. In some examples, a training job includes training of a ML model using a training file (e.g., that records customer-specific training data). In some examples, an inference job includes using a ML model to provide a prediction, also referred to herein as an inference result. In the context of CashApp, the training data can include invoice to bank statement matches as examples provided by a customer, which training data is used to train a ML model to predict invoice to bank statement matches. Also in the context of CashApp, the data files can include an invoice data file and a bank statement data file that are ingested by a ML model to predict matches between invoices and bank statements in an inference process.

With continued reference to FIG. 2, the application jobs module 220 includes a training dataset provider sub-module 222, a training submission sub-module 224, an open items provider sub-module 226, an inference submission sub-module 228, and an inference retrieval sub-module 230. In some examples, for a training job, the training dataset provider sub-module 222 and the training submission sub-module 224 function to request a training job from and provide training data to the cloud platform 206. In some examples, for an inference job, the training dataset provider sub-module 222 and the training submission sub-module 224 function to request a training job from and provide training data to the cloud platform 206.

In some implementations, the cloud platform 206 hosts at least a portion of the ML application (e.g., CashApp) to execute one or more jobs (e.g., training job, inference job). In the example of FIG. 2, the cloud platform 206 includes one or more application gateway application programming interfaces (APIs) 240, application inference workers 242 (e.g., matching worker 270, identification worker 272), a message broker 244, one or more application core APIs 246, a ML system 248, a data repository 250, and an auto-scaler 252. In some examples, the application gateway API 240 receives job requests from and provides job results to the enterprise system 204 (e.g., over a REST/HTTP [oAuth] connection). For example, the application gateway API 240 can receive training data 260 for a training job 262 that is executed by the ML system 248. As another example, the application gateway API 240 can receive inference data 264 (e.g., invoice data, bank statement data) for an inference job 266 that is executed by the application inference workers 242, which provide inference results 268 (e.g., predictions).

In some examples, the enterprise system 204 can request the training job 262 to train one or more ML models using the training data 262. In response, the application gateway API 240 sends a training request to the ML system 248 through the application core API 246. By way of non-limiting example, the ML system 248 can be provided as SAP AI Core. In the depicted example, the ML system 248 includes a training API 280 and a model API 282. The ML system 248 trains a ML model using the training data. In some examples, the ML model is accessible for inference jobs through the model API 282.

In some examples, the enterprise system 204 can request the inference job 266 to provide the inference results 268, which includes a set of predictions from one or more ML models. In some examples, the application gateway API 240 sends an inference request, including the inference data 264, to the application inference workers 242 through the message broker 244. An appropriate inference worker of the application inference workers 242 handles the inference request. In the example context of matching invoices to bank statements, the matching worker 270 transmits an inference request to the ML system 248 through the application core API 246. The ML system 248 accesses the appropriate ML model (e.g., the ML model that is specific to the customer and that is used for matching invoices to bank statements), which generates the set of predictions. The set of predictions are provided back to the inference worker (e.g., the matching worker 270) and are provided back to the enterprise system 204 through the application gateway API 240 as the inference results 266. In some examples, the auto-scaler 252 functions to scale the inference workers up/down depending on the number of inference jobs submitted to the cloud platform 206.

To provide further context for implementations of the present disclosure, and as introduced above, the problem of matching entities represented by computer-readable records (electronic documents) appears in many contexts. Example contexts can include matching product catalogs, deduplicating a materials database, and matching incoming payments from a bank statement table to open invoices, the example context introduced above.

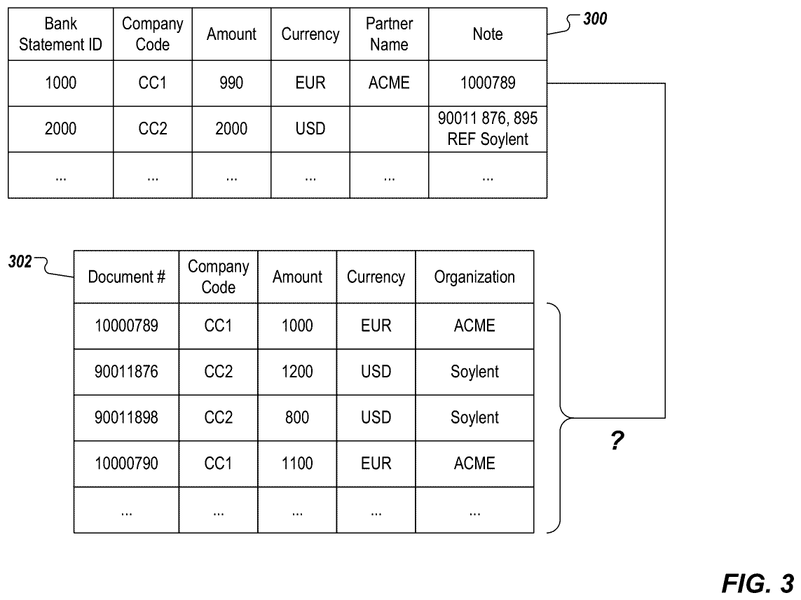

In the example context, FIG. 3 depicts portions of example electronic documents. In the example of FIG. 3, a first electronic document 300 includes a bank statement table that includes records representing payments received, and a second electronic document 302 includes an invoice table that includes invoice records respectively representing invoices that had been issued. In the example context, each bank statement record is to be matched to one or more invoice records. Accordingly, the first electronic document 300 and the second electronic document 302 are processed using one or more ML models that provide predictions regarding matches between a bank statement record (entity) and one or more invoice records (entity/-ies) (e.g., using CashApp, as described above).

To achieve this, a ML model (matching model) is provided as a classifier that is trained to predict entity pairs to a fixed set of class labels (\vec{l}) (e.g., l₀, l₁, l₂). For example, the set of class labels (\vec{l}) can include ‘no match’ (l₀), ‘single match’ (l₁), and ‘multi match’ (l₂). In some examples, the ML model is provided as a function f that maps a query entity (\vec{a}) and a target entity (\vec{b}) into a vector of probabilities (\vec{p}) (also called ‘confidences’ in the deep learning context) for the labels in the set of class labels. This can be represented as:

$$f ( \vec{a} , \vec{b} ) = ( \begin{matrix}{p}_{0} \\ {p}_{1} \\ {p}_{2}\end{matrix} )$$

where \vec{p}={p₀, p₁, P₂}. In some examples, P₀ is a prediction probability (also referred to herein as confidence c) of the item pair \vec{a}, \vec{b} belonging to a first class (e.g., no match), p₁ is a prediction probability of the item pair \vec{a}, \vec{b} belonging to a second class (e.g., single match), and p₂ is a prediction probability of the item pair \vec{a}, \vec{b} belonging to a third class (e.g., multi match).

Here, p₀, p₁, and P₂ can be provided as numerical values indicating a likelihood (confidence) that the item pair \vec{a}, \vec{b} belongs to a respective class. In some examples, the ML model can assign a class to the item pair \vec{a}, \vec{b} based on the values of p₀, p₁, and p₂. In some examples, the ML model can assign the class corresponding to the highest value of p₀, p₁, and p₂. For example, for an entity pair \vec{a}, \vec{b}, the ML model can provide that p₀=0.13, p₁=0.98, and p₂=0.07. Consequently, the ML model can assign the class ‘single match’ (l₁) to the item pair \vec{a}, \vec{b}.

As introduced above, entity matching can be generally described as matching entities (queries) from one table to a single or a set of entities (targets) in another table based on some inherent relationships. Decomposing the problem by focusing on individual query-target entity pairs, the problem becomes a ternary classification task. Using features of the query entity and the target entity, a ML model predicts whether a query-target entity pair belongs to one of multiple classes. For example, and with reference to the examples above, classes can include a single match (i.e., the query entity is only matched with the current target entity), a multi match (i.e., the query entity is matched with the current target entity and one or more other target entities), and no match (i.e., the query entity does not match with the current target entity). Though this approach ensures there is a fixed number of classes regardless of the multiplicity of the matches, it is computationally expensive. For example, matching to multiple classes has a time complexity of O(n_{q}×nₜ), where n_{q} is the number of query entities and nₜ is the number of target entities. This is because all n_{q}×nₜ query-target entity pairs must be inferred even though only a small fraction of query-target entity pairs are true matches.

An approach to reducing time complexity of inference is to filter entity pairs that are already determined to be potential matches and only providing those entity pairs for consideration by the ML model. In this manner, only entity pairs that are already determined to be potential matches are provided to the ML model. Looked at another way, if it can be determined that a particular target entity is not a match to a particular query entity, that particular entity pair is filtered from being processed by the ML model during inference. In this manner, the ML model is only processing entity pairs that there is some level of confidence will be a match.

One approach to achieve such filtering is to use user-defined rules to reduce the number of query-target entity pairs prior to inference using the ML model. For example, and in the example context of matching banks statements to invoices, an example rule can restrict bank statement and invoice pairs to those sharing the same company code (i.e., the bank statement and the invoice have the same company code associated therewith). Though this approach has been easy to incorporate and provides some success in reducing the time complexity of inference, it is still incapable of significantly reducing the number of inferred pairs in many real-world cases to have an appreciable impact on the time complexity.

For example, multiple invoices may share the same company code with a bank statement, and hence would not be filtered even though not being a match to the bank statement. In other words, the amount of entity items reduced using user-defined rules may not have a significant impact on reducing the number of entity pairs, and hence on the time complexity of inference using the ML model. This problem can be mitigated in the short term by increasing the number of rules and/or providing more complex rules to segment the entities. However, this decreases the generalizability of filtering and would require a high level of domain knowledge to ensure designed rules do not affect matching accuracy. In addition, rules may be difficult to implement for non-categorical features. For example, implementing rules involving the matching of keywords or phrases in text fields of each query-target entity pair may be difficult due to the presence of typographical errors and/or differences in sentence structure.

In view of the above context, implementations of the present disclosure provide pre-filtering (i.e., before predicting matches using a ML model during inference) using sentence embedders to automatically generate features determined to be relevant for comparison and filters leveraging nearest neighbour search techniques to shortlist highly probable candidate matches of entity pairs. Entity pairs not included in the shortlist are excluded from consideration by the ML model, thereby reducing the number of entity pairs processed by the ML model with a commensurate reduction in inference time and technical resources expended. This is achieved without compromising accuracy and proposal rate.

More particularly, and as described in further detail herein, implementations of the present disclosure dynamically determine a filtering threshold by calculating a maximum threshold to achieve a desired recall score (true positive rate) on a validation set. In some examples, the filtering threshold ensures accuracy loss is not incurred due to ground-truth entity pairs being excluded before inference. Entity embeddings are compared to determine similarity scores therebetween and, if the similarity score meets or exceeds the filtering threshold, the respective entity pair is filtered as a filtered entity pair. Each filtered entity pair is determined to be a likely match and is provided to the ML model for inference. In some examples, filtered entity pairs are stored in a file structure that includes batches of indexed entity pairs to conserve memory and to reduce the saving and loading time of entity pairs during inference. During inference, filtered entity pairs are retrieved from the file structure for processing by the ML model. Implementations of the present disclosure dynamically determine query entities undergoing filtering based on a number of potential targets. This ensures time is not spent indexing and filtering entity pairs for data sets with a relatively small numbers of targets.

In further detail, implementations of the present disclosure filter query entities and target entities in a multi-stage process. In some implementations, during indexing, a target entity embedding is generated for each target entity using an embedder, and the target entity embeddings are stored as an index. An example embedder includes, without limitation, a fine-tuned Siamese Bidirectional Encoder Representations from Transformers (BERT) embedder. In some examples, an embedding can be described as a representation of a given data instance, such as a target entity, in a high-dimensional vector space. In practice, an embedding is a vector of m floating point numbers. During indexing, different index types may be used to reduce index size or improve filtering performance.

In some implementations, an example neural network architecture of a Siamese BERT embedder includes a query entity side and a target entity side that each includes a tokenizer layer, a BERT layer, and an average pooling layer. In some examples, weights are shared between the BERT layers of the query entity side and the target entity side. In some examples, the query entity side outputs a query entity embedding (e.g., a vector \vec{u}) and the target entity side outputs a target entity embedding (e.g., a vector \vec{v}). More particularly, the output of the pretrained BERT deep learning model is reduced to an embedding vector (\vec{u}, \vec{v}) using average pooling and fine-tuned (trained further) using contrastive loss, which results in a well-organized embedding space where embedding vectors of related entities cluster together and unrelated entities are pushed away from each other. It can be noted that, in a Siamese architecture both, query entities and target entities are encoded using the same mapping function. In some examples, pre-processing of tabular entities is executed to supply the entities to the respective tokenizers (e.g., a BERT Model Tokenizer), which takes natural language strings as input. For example, for a table containing bank statement line items, which would be the query entities for bank-statement to invoice matching, these entities are pre-processed by converting the values for each field to strings that are then concatenated. To help distinguish different fields, special separator tokens (e.g., <q₀>, <q₁>, <q₂>, . . . ) are inserted for each field. The pre-processing for the target entities is done in analogous manner.

During filtering, a query entity embedding is generated for each query entity using the same embedder as used to generate the target entity embedding. In some examples, similarity scores between query entities and target entities are calculated using a similarity measure between embeddings. An example similarity score can include, without limitation, cosine similarity. A similarity threshold (filtering threshold) is used to shortlist pairs for inference (e.g., query-target entity pairs with a similarity score higher than the threshold will be processed by the ML model during inference). Distributions of similarity scores of no match, single match, and multi match pairs depend on multiple factors. Example factors include a length of embedder fine-tuning and data drift between training data used to train the embedder and the inference data. Consequently, an optimal similarity threshold (filtering threshold) that balances both entity matching accuracy and speed may vary greatly between data sets. In view of this, implementations of the present disclosure provide a dynamic approach to determining a similarity threshold.

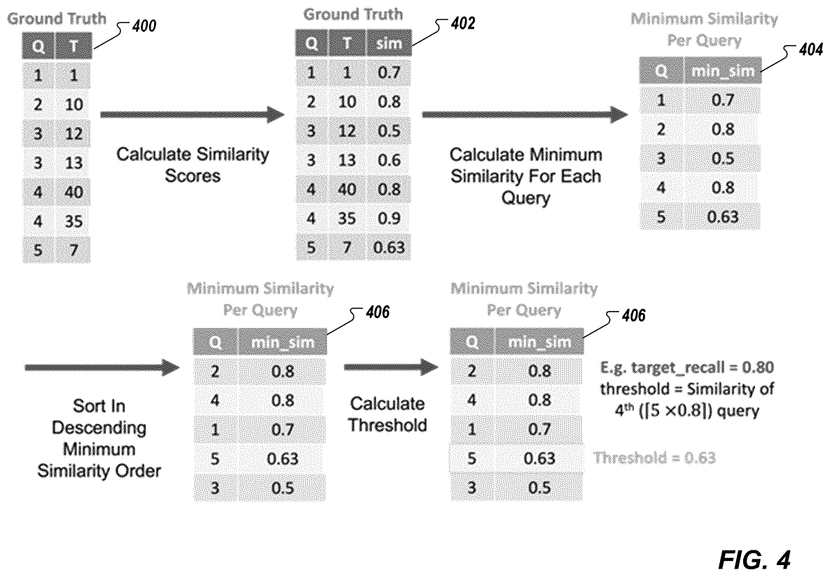

FIG. 4 depicts example similarity threshold (filtering threshold) determination in accordance with implementations of the present disclosure. In the example of FIG. 4, a ground truth table 400 of query entities (Q) and target entities (T) is provided and similarity scores are determined for each query entity and target entity pair to provide a similarity table 402. In some examples, the ground truth table 400 includes query entity and target entity pairs provided in a validation set. For example, in training a ML model historical data is used and includes query-target entity pairs and a match indication (e.g., no, single, multi) for each pair. Accordingly, each query-entity pair with match indication can be considered a ground truth. The historical data is divided into training data, testing data, and validation data. The training data is used to train the ML model (i.e., the ML model that predicts matches between query entities and target entities). The testing data is used to test the trained ML model (e.g., for accuracy). The validation data is used to validate the trained (and tested) ML model. In accordance with implementations of the present disclosure, the validation data is also used to select the similarity threshold, as described herein. With continued reference to FIG. 4, a minimum similarity is determined for each unique query entity to provide a minimum similarity table 404, which is then sorted in descending minimum similarity order to provide a sorted query entity table 406. A similarity threshold is selected.

In further detail, the similarity threshold (filtering threshold) is determined, such that negligible effects on entity matching accuracy can be achieved with maximum increase in inference speed. Using cosine similarity as an example of a similarity score used during filtering and assuming a target recall score (e.g., 0.99), the cosine similarities for each ground truth entity pair in the validation set are determined (e.g., cosine similarity between query entity embedding and target entity embedding of each ground truth pair). In some examples, the target recall score is calculated as:

$$recall = \frac{Number of total match queries in the filtered pair set}{Number of queries with matches}$$

Calculating the target recall score as such, the similarity threshold cannot be determined as the cosine similarity of the first percentile of validation query-target pairs. Instead, the minimum cosine similarities (min_sim) of all ground-truth pairs of each query is determined. The optimal similarity threshold is set to the min_sim of the first percentile of validation queries. In this manner, implementations of the present disclosure find the greatest possible similarity threshold to achieve at least the target recall score (e.g., 0.99) on the validation set. Once the similarity threshold is determined, it is used as a filtering threshold for subsequent query-target entity pair filtering before inference.

To provide further detail on calculating recall scores, the following example tables can be considered:

TABLE 1
Example Ground Truth Pairs
Ground Truth Pairs

| Query (Q) | Target (T) |
|---|---|
| Q1 | T1 |
| Q2 | T3 |
| Q2 | T4 |
| Q3 | T2 |
| Q3 | T5 |
| Q4 | T10 |

TABLE 2
Example Filtered Pairs
Filtered Pairs

| Query (Q) | Target (T) |
|---|---|
| Q1 | T1 |
| Q2 | T3 |
| Q2 | T4 |
| Q3 | T2 |

Here, Table 1 contains true matches between query entities and target entities (from the validation set), while Table 2 contains pairs after filtering with a similarity threshold. Ground truth pairs absent from Table 1 include [Q3, T5] and [Q4, T10]. In the above examples, Q1 and Q2 are total match queries, because all of their ground truth matches can be found in Table 2. Q3 and Q4 are not total matches, because one of their ground truth matches of each is absent From Table 2. Hence, the recall score in this example is 2/4=0.5.

After query-target entity pairs have been filtered, they are temporarily persisted in computer-readable memory. In inference data sets with large numbers of query entities and target entities, the set of filtered query-target entity pairs may still be relatively large (e.g., >500 million pairs). Consequently, even relatively simple storage methods, such as storing all pairs into a single .csv file with two columns of query and target keys, can incur long storing and loading times as well as occupy a considerable amount of memory. In addition, storing all query-target entity pairs into a single file entails the mass loading of all pairs even for the purpose of retrieving pairs for a single query.

In view of this, implementations of the present disclosure provide a file structure that provides a relatively low memory footprint and writing/reading times for storage and retrieval of filtered query-target entity pairs, as query-target index pairs. More particularly, in accordance with implementations of the present disclosure, query-target index pairs are stored instead of query-target key pairs. This is because long string keys take more memory to store than integer indices. In some examples, filtered query-target entity pairs are stored in dictionaries (hashmap data structures) to avoid repetition of query indices in the file structure. In accordance with implementations of the present disclosure, deserialization time is saved due to the multiple reasons. For example, because file sizes are small, loading time is faster. As another example, the use of the hashmap data structure reduces retrieval time (i.e., time taken to retrieve pairs of a query). As another example, when retrieving pairs of a single query, only one batch filtered pair file has to be loaded, which reduced the amount of memory required in the filtering stage. Serialization time is also saved due to the relatively smaller file sizes.

Table 3, below, compares the performances of both approaches and demonstrates the substantial improvements in file size, dumping time and retrieval time with the approach of the present disclosure:

TABLE 3
Example Storage Approach Comparison

| | File | Saving | Loading |
|---|---|---|---|
| Storage Approach | Size (GB) | Time (s) | Time (s) |
| .csv file of key pairs | 45.0 | 2470 | 740 |
| Index Pair Dictionaries | 3.10 | 19.2 | 0.157 |

The example of Table 3 provides a comparison of filtered pair file sizes, saving times, and loading times for 725 million query-target pairs. The file sizes refer to the sum of sizes of all stored files (for a 369 pickled dictionaries approach), where file size refers to the summation of file sizes of all index-key maps and batches of serialized dictionaries. Saving time refers to the amount of time spent serializing the dictionaries. Loading time refers to the amount of time taken to deserialize pairs of a single query.

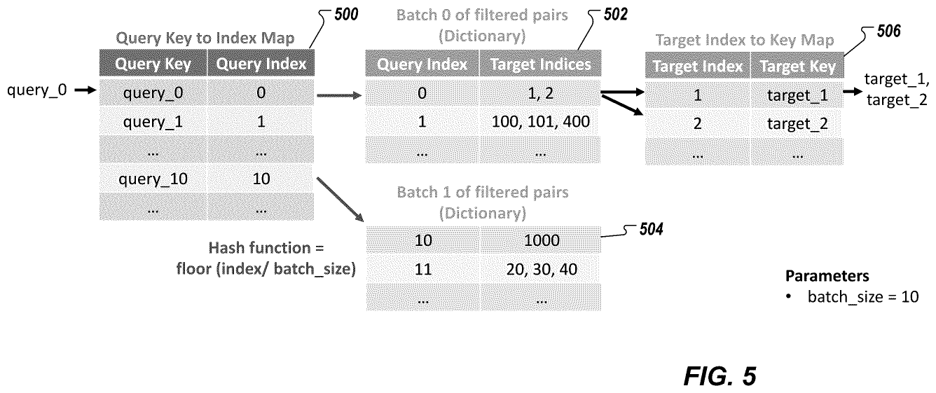

FIG. 5 depicts an example file structure for storage and retrieval of filtered query-target entity pairs (index pairs) in accordance with implementations of the present disclosure. The example file structure of FIG. 5 provides for the storage of filtered pairs in a manner that conserves storage space and reduces saving/loading times to other approaches (e.g., single .csv file).

In accordance with implementations of the present disclosure, and as depicted in FIG. 5, multiple file types are provided. The example file types include a query key to index map 500, batches 502, 504, and a target index to key map 506. In some examples, the query key to index map 500 defines a query index for each query key. In some examples, each batch 502, 504 records respective filtered index pairs to provide a respective dictionary of query indices to lists of target indices. Although two batches are depicted in the example of FIG. 5, implementations of the present disclosure can include any appropriate number of batches. In some examples, the target index to key map 506 maps a given target index to a target key. In the example of FIG. 5, it is shown how filtered target keys of query_0 can be retrieved. First, the query key is mapped to a query index with the query key to index map 500, the batch number containing the filtered pairs of query_0 is calculated using a hash function (e.g., index/batch_size, where batch_size refers to the number of queries in each batch of filtered pairs). After loading the batch of filtered pairs, filtered target indexes of query_0 can be retrieved using the query index (0) and the filtered pair dictionary. The filtered target keys are retrieved from the target index to key map 506.

Although filtering of query-target entity pairs reduces the number of pairs sent to inference, therefore reducing inference runtimes and providing other technical advantages, the savings from filtering decreases with decreasing numbers of target entities in the inference data set. This suggests that, below a certain number of target entities, filtering no longer remains beneficial. For example, a query entity with 100 target entities before filtering may only observe a 30% decrease in target entities through filtering. This translates to a negligible decrease in inference time, and this decrease may be smaller than the time taken to execute filtering. In addition, the reduction in inferred target entities may in turn affect the accuracy of entity matching should some of the ground truth pairs be excluded during filtering.

To mitigate the above issues, implementations of the present disclosure provided that query entities with less than a threshold number of target entities (few-match queries) are dynamically excluded from the filtering pipeline. This is determined at the time of inference. Only query entities with target entities at or above the threshold number of target entities undergo filtering. After filtering, non-filtered pairs of few-match query entities and filtered pairs of many-match query entities are process during inference

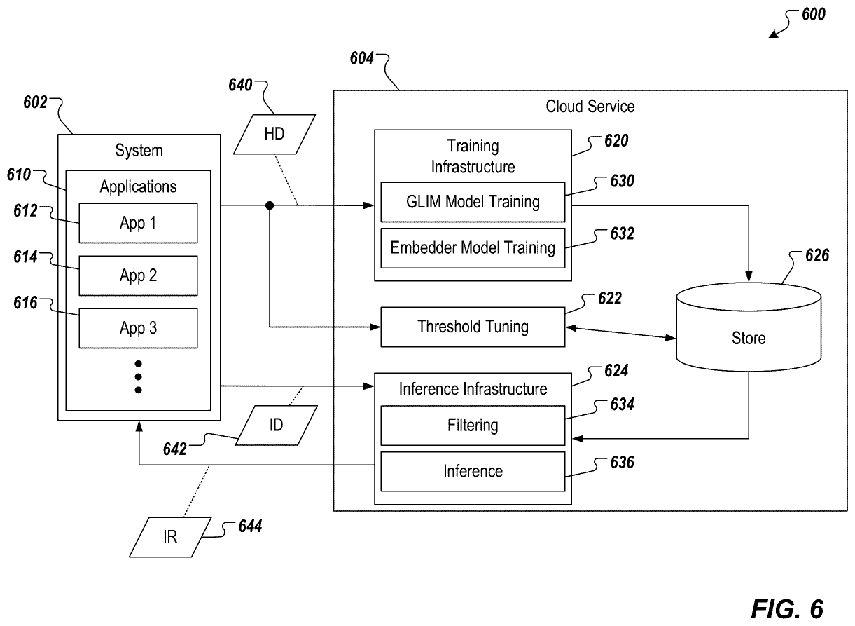

FIG. 6 depicts an example conceptual architecture 600 in accordance with implementations of the present disclosure. In the example of FIG. 6, the conceptual architecture 600 includes an enterprise system 602 (e.g., SAP S/4 HANA (either cloud or on premise)) and a cloud service 604. The enterprise system 602 executes a set of applications 610 including applications 612, 614, 616. In some examples, one or more of the applications 612, 614, 616 submit inference jobs to the cloud service 604 to receive inference results therefrom. In the example of FIG. 6, the cloud service 604 is executed within a cloud platform to perform training services and inference services.

The example of FIG. 6 represents incorporation of entity pair filtering into an existing entity matching infrastructure in accordance with implementations of the present disclosure. By way of non-limiting example, the applications 610 can be provided using the S/4 HANA system (either cloud or on-premise) running different applications 612, 614, 616 (CashApp FI-AR, CashApp FI-CA, Inter Company Reconciliation) that consume ML-based entity matching provided by the cloud service 604. Implementations of the present disclosure are described in further detail with reference to FIG. 6 in the context of the S/4 HANA application CashApp, introduced above.

In the example of FIG. 6, the cloud service 604 includes a training infrastructure 620, a threshold tuning module 622, an inference infrastructure 624, and a store 626. The training infrastructure 620 includes a Generic Line-Item Matching (GLIM) model training module 630 and an embedding model training module 632. The inference infrastructure 624 includes a filtering module 634 and an inference module 636. In some examples, the GLIM model training module 630 trains a GLIM model based on historical data (HD) 640. The (trained) GLIM model is stored in the store 626 and is used during inference to predict matches between query entities and target entities in the example context of matching bank statements to invoices, as described herein. In some examples, the embedding model training module 632 trains an embedding model (e.g., Siamese BERT model) that provides query entity embeddings and target entity embeddings, as described herein. In some examples, the threshold tuning module 622 determines the similarity threshold that is to be used for filtering, as described herein, and stores the similarity threshold in the store 626. In some examples, the filtering module 634 filters query-target entity pairs from inference data (ID) 642, as described herein, and stores the filtered query-target entity pairs in a memory- and time-efficient file structure, as described herein. In some examples, the inference module 636 loads the GLIM model and executes inference by processing the non-filtered query entities and target entities to determine matches therebetween, which are provided as inference results (IR) 644.

In further detail, CashApp (e.g., one of the applications 612, 614, 616) sends the historical data 640 to the cloud service 604. The historical data 640 includes, for example and in the example context, bank statement (query) records, invoice (target) records, and ground truth bank statement-invoice matches. The bank statement records include features of different data types (e.g. memo line (string), posting date (date), country key (categorical)). The invoice records share some similar features to the bank statements (e.g., company code) and also include features of different data types. The ground truth data includes matching pairs of query and target keys and their matching types. The historical data 640 is used by the training infrastructure 620 to train both the GLIM model and the embedding model.

More particularly, in response to receiving the historical data 640, a GLIM model training job and an embedding model training job are triggered. In some examples, the training jobs can run in parallel or asynchronously. The training jobs differ in their class labels. During embedding model training, for example, both single and multi matches share the same class label, whereas during GLIM model training the single and the multi matches have different class labels.

After completing embedding model training, threshold tuning is executed using the embedding model, as described herein (e.g., the embedder module provides query entity embeddings and target entity embedding from a validation set of the historical data 640). More particularly, during threshold tuning, query entities and target entities of a validation set undergo embedding and filtering, starting with a strict filtering threshold. After filtering, the recall score of the filtered pairs is calculated. If it is below the target recall score (e.g., 0.99), the filtering threshold is relaxed (decremented) and the above process is repeated. When the target recall score is attained, the prevailing similarity threshold is saved as an optimal filtering threshold for future inference jobs.

An inference request is sent from CashApp, the inference request including the inference data 642 with bank statement records and invoice records. An inference job is subsequently triggered. In some examples, in the event the GLIM model is trained, but the embedding model training and the threshold tuning are still ongoing, the inference job continues without pre-filtering. When all models have been trained and threshold tuned, entity pair filtering will be carried out prior to inference to reduce the number of pairs sent to the GLIM model (executed by the inference module 636) for prediction. During inference (prediction), bank statement-invoice pairs are classified by the GLIM model as one of the following example classes: “no match”, “single match,” or “multi-match.” Once the inference job has finished, the inference results 644 are provided to the CashApp.

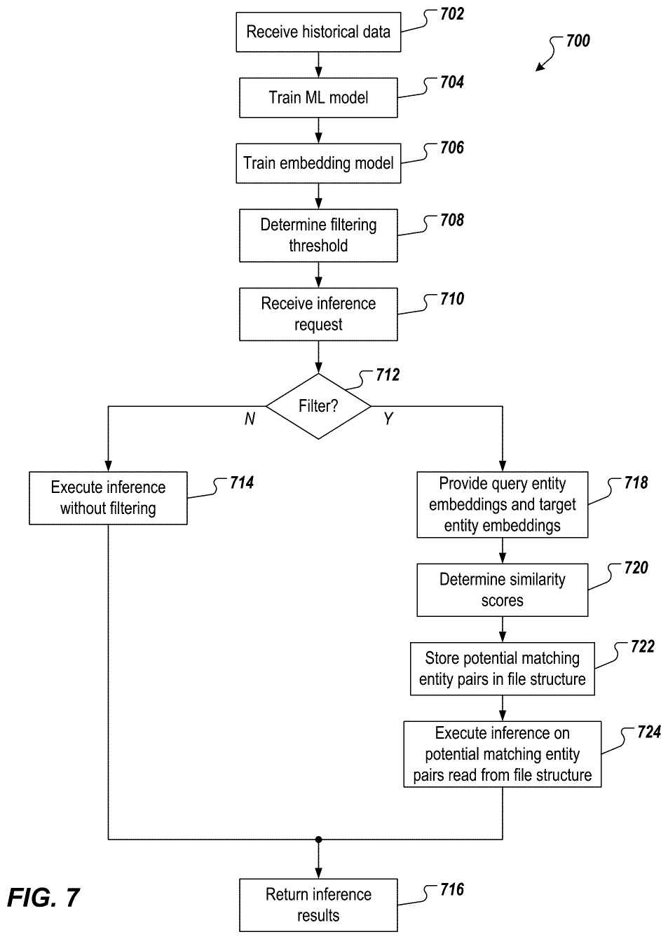

FIG. 7 depicts an example process 700 that can be executed in accordance with implementations of the present disclosure. In some examples, the example process 700 is provided using one or more computer-executable programs executed by one or more computing devices.

Historical data is received (702). For example, and as described herein by way of non-limiting example with reference to FIG. 6, CashApp (e.g., one of the applications 612, 614, 616) sends the historical data 640 to the cloud service 604. The historical data 640 includes, for example and in the example context, bank statement (query) records, invoice (target) records, and ground truth bank statement-invoice matches. The bank statement records include features of different data types (e.g. memo line (string), posting date (date), country key (categorical)). The invoice records share some similar features to the bank statements (e.g., company code) and also include features of different data types. The ground truth data includes matching pairs of query and target keys and their matching types (e.g., single, multi).

A ML model is trained (704) and an embedding model is trained (706). For example, and as described herein, the historical data 640 is used by the training infrastructure 620 to train both the GLIM model (i.e., the ML model used during inference to label query-target entity pairs with respective match labels) and the embedding model (i.e., the ML model used to generate query entity embeddings and target entity embeddings). More particularly, in response to receiving the historical data 640, a GLIM model training job and an embedding model training job are triggered. In some examples, the training jobs can run in parallel or asynchronously. The training jobs differ in their class labels. During embedding model training, for example, both single and multi matches share the same class label, whereas during GLIM model training the single and the multi matches have different class labels. In some examples, training of the ML model and the embedding model is executed using a training data set and a testing data set of the historical data.

A filtering threshold is determined (708). For example, and as described herein, a query entity embedding is determined for each query entity in a validation set of the historical data and a target entity embedding is determined for each target entity in the validation set of the historical data. A similarity score is determined for each query-target entity pair in the validation set and a minimum similarity score is determined for each unique query (e.g., to provide the minimum similarity table 404 of FIG. 4). The unique queries are sorted in descending order based on minimum similarity score and a filtering threshold (similarity score) is determined based on a target recall score.

An inference request is received (710). For example, and as described herein, an inference request is sent from CashApp, the inference request including the inference data 642 with bank statement records and invoice records, in the example context of matching bank statements to invoices. An inference job is subsequently triggered. It is determined whether filtering of the inference data is to be performed (712). For example, and as described herein, in the event that the ML model (e.g., GLIM model) is trained, but the embedding model training and the threshold tuning are still ongoing, the inference job continues without filtering.

If filtering of the inference data is not to be performed, inference is executed without filtering (714) and inference results are returned (716). For example, and as described herein, during inference (prediction), query-target entity pairs included in the non-filtered inference data are classified by the ML model (e.g., GLIM model) into a class of a set of classes (e.g., “no match”, “single match,” “multi-match”). Once the inference job has finished, the inference results 644 are provided to the CashApp.

If all models have been trained and threshold tuned, entity pair filtering can be carried out prior to inference to reduce the number of pairs sent to the ML model (executed by the inference module 636) for prediction. Accordingly, if filtering of the inference data is to be performed, query entity embeddings and target entity embeddings are provided (718). For example, and as described herein, a query entity embedding is determined for each query entity in the inference data 642 and a target entity embedding is determined for each target entity in the inference data 642 by respectively processing the query entities and the target entities through the embedding module. Similarity scores are determined for each query entity and target entity pair (720). For example, and as described herein, for each query-target entity pair in the inference data 642, the query entity embedding is compared to the target entity embedding to determine a similarity score (e.g., a cosine similarity score).

Potential matching query-target entity pairs are stored in a file structure (722). For example, and as described herein, each similarity score of the query-target entity pairs is compared to the filtering threshold. If a similarity score meets or exceeds the filtering threshold, the respective query-target entity pair is filtered as a potential matching query-target entity pair and is stored in the file structure, as described herein with reference to FIG. 5. Any query-target entity pair having a similarity score that does not at least meet the filtering threshold, is not stored in the file structure and is not considered during inference. Inference is executed on the potential matching query-target entity pairs read from the file structure (724) and inference results are returned (716).

Implementations of the present disclosure provide one or more technical advantages. One example advantage is that implementations of the present disclosure provide scalable entity matching by filtering target items through an embedding model before downstream inference using a matching model (e.g., GLIM model). This reduces the search space for the downstream matching model thereby reducing the inference times by several orders compared to matching without filtering. With such an approach a query entity can be matched to target entities within acceptable run times even when the size of the latter is in the order of several millions, for example. The end-to-end combination of the embedding model followed by the matching model improves the proposal rate and accuracy of the end-to-end matching over traditional approaches. Further, implementations of the present disclosure utilize an embedding model (e.g., Siamese BERT model) that is fine-tuned on training data with field separators. The field separators help the embedding model in distinguishing between the various features/fields in the query and target entities. This enables the embedding model to learn good embeddings of the target/query entities. As another example, the embeddings provided by the embedding model are utilized to do a relatively fast search to identify candidate target entities that potentially match a given query entity. The search is done either through brute force search or approximate nearest neighbor (ANN) search. Implementations of the present disclosure also provide a dynamic similarity threshold determination approach used to determine the minimum threshold that is required to get a specific recall (e.g., 99%) based on the given training data (as training data is representative of the inference data). This threshold is used during inference time to filter targets with minimal impact on recall. Implementations of the present disclosure utilize integer target keys and indexes stored in small batches to minimize the memory footprint of indices for search and filtering.

As noted above, implementations of the present disclosure significantly shorten inference time by decreasing the number of query-target pairs that are to be processed by the ML model during inference. For example, and using an example data set of 200 query entities (bank statements) and 500,823 target entities (invoices), a total of 100,164,600 query-target pairs would need to be processed by the ML model without filtering. Implementations of the present disclosure reduced the number of query-target pairs to 3,717,349 (3.7%). That is, for the example data set, implementations of the present disclosure reduce the load on the inference system by approximately 96.3%. This results in an approximate 12 times reduction in the total inference time (e.g., including indexing, filtering, inference, and post-processing).

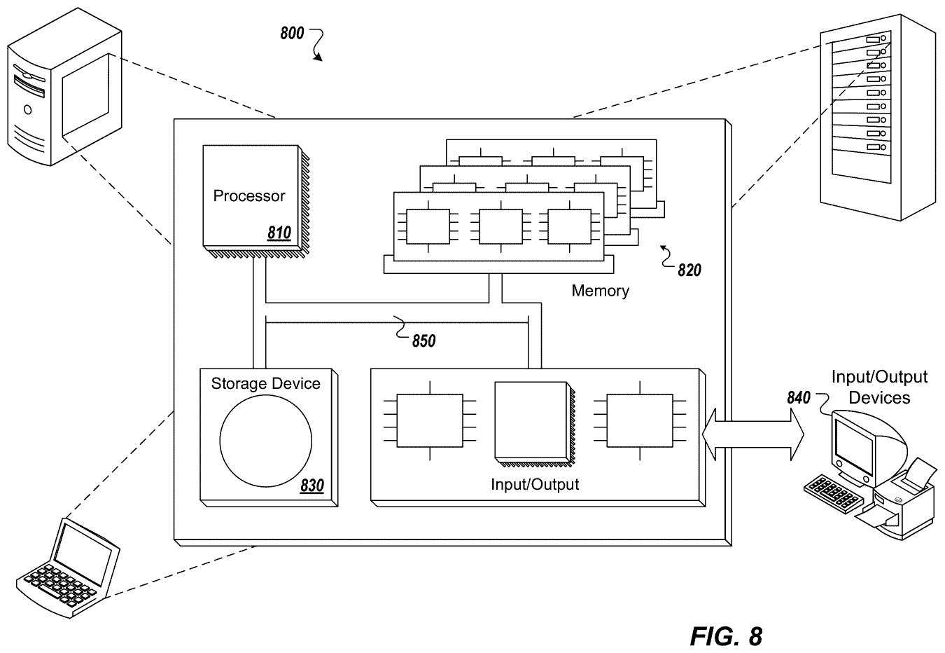

Referring now to FIG. 8, a schematic diagram of an example computing system 800 is provided. The system 800 can be used for the operations described in association with the implementations described herein. For example, the system 800 may be included in any or all of the server components discussed herein. The system 800 includes a processor 810, a memory 820, a storage device 830, and an input/output device 840. The components 810, 820, 830, 840 are interconnected using a system bus 850. The processor 810 is capable of processing instructions for execution within the system 800. In some implementations, the processor 810 is a single-threaded processor. In some implementations, the processor 810 is a multi-threaded processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. In some implementations, the memory 820 is a volatile memory unit. In some implementations, the memory 820 is a non-volatile memory unit. The storage device 830 is capable of providing mass storage for the system 800. In some implementations, the storage device 830 is a computer-readable medium. In some implementations, the storage device 830 may be a floppy disk device, a hard disk device, an optical disk device, or a tape device. The input/output device 840 provides input/output operations for the system 800. In some implementations, the input/output device 840 includes a keyboard and/or pointing device. In some implementations, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASIC s (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for matching a query entity to one or more target entities using machine learning (ML) models, the method being executed by one or more processors and comprising:
receiving historical data comprising a set of ground truth query-target entity pairs;
determining a filtering threshold based on similarity scores of a validation set of ground truth query-target entity pairs of the historical data, the validation set of ground truth query-target entity pairs being a sub-set of the set of ground truth query-target entity pairs of the historical data;
receiving inference data comprising a set of query entities and a set of target entities, each query entity in the set of query entities to be matched to one or more target entities of the set of target entities;
providing, by an embedding module, a set of query entity embeddings and a set of target entity embeddings;
defining a set of query-target entity pairs, each query-target entity pair comprising a query entity of the set of query entities and a target entity of the set of target entities;
for each query-target entity pair in the set of query-target entity pairs, determining a similarity score;
filtering query-target entity pairs from the set of query-target entity pairs based on respective similarity scores to provide a set of filtered query-target entity pairs, the set of filtered query-target entity pairs having fewer query-target entity pairs than the set of query-target entity pairs;
executing, by a ML model, inference on each filtered query-target entity pair in the set of filtered query-target entity pairs, during inference, the ML model assigning a label to each filtered query-target entity pair.

2. The method of claim 1, wherein determining the filtering threshold comprises:
determining a similarity score between a query entity and a target entity of respective ground truth query-target entity pairs;
determining a minimum similarity score for each unique query entity in the validation set of ground truth query-target entity pairs to provide a set of minimum similarity scores;
sorting minimum similarity scores in descending order; and
selecting the filtering threshold as a minimum similarity score in the set of similarity score based on a target recall score.

3. The method of claim 1, wherein the embedding model and the ML model are trained using a training set of the historical data.

4. The method of claim 1, wherein each ground truth query-target entity pair in the set of ground truth query-target entity pairs is assigned with a label indicating a type of match between a query entity and a target entity of the respective ground truth query-target entity pair.

5. The method of claim 1, wherein the label indicates a type of match for respective filtered query-target entity pairs.

6. The method of claim 1, further comprising:
storing the set of filtered query-target entity pairs in a file structure comprising a set of dictionaries, each dictionary recording a respective sub-set of filtered query-target entity pairs as a batch; and
during inference, reading filtered query-target entity pairs from the file structure for processing by the ML model.

7. The method of claim 6, wherein the file structure further comprises a query key to index map that maps each query entity to a sub-set of filtered query-target entity pairs, and a target index to key map that maps indices of target entities determined from the sub-sets of filtered query-target entity pairs to respective target keys.

8. A non-transitory computer-readable storage medium coupled to one or more processors and having instructions stored thereon which, when executed by the one or more processors, cause the one or more processors to perform operations for matching a query entity to one or more target entities using machine learning (ML) models, the operations comprising:
receiving historical data comprising a set of ground truth query-target entity pairs;
determining a filtering threshold based on similarity scores of a validation set of ground truth query-target entity pairs of the historical data, the validation set of ground truth query-target entity pairs being a sub-set of the set of ground truth query-target entity pairs of the historical data;
receiving inference data comprising a set of query entities and a set of target entities, each query entity in the set of query entities to be matched to one or more target entities of the set of target entities;
providing, by an embedding module, a set of query entity embeddings and a set of target entity embeddings;
defining a set of query-target entity pairs, each query-target entity pair comprising a query entity of the set of query entities and a target entity of the set of target entities;
for each query-target entity pair in the set of query-target entity pairs, determining a similarity score;
filtering query-target entity pairs from the set of query-target entity pairs based on respective similarity scores to provide a set of filtered query-target entity pairs, the set of filtered query-target entity pairs having fewer query-target entity pairs than the set of query-target entity pairs; and
executing, by a ML model, inference on each filtered query-target entity pair in the set of filtered query-target entity pairs, during inference, the ML model assigning a label to each filtered query-target entity pair.

9. The non-transitory computer-readable storage medium of claim 8, wherein determining the filtering threshold comprises:
determining a similarity score between a query entity and a target entity of respective ground truth query-target entity pairs;
determining a minimum similarity score for each unique query entity in the validation set of ground truth query-target entity pairs to provide a set of minimum similarity scores;
sorting minimum similarity scores in descending order; and
selecting the filtering threshold as a minimum similarity score in the set of similarity score based on a target recall score.

10. The non-transitory computer-readable storage medium of claim 8, wherein the embedding model and the ML model are trained using a training set of the historical data.

11. The non-transitory computer-readable storage medium of claim 8, wherein each ground truth query-target entity pair in the set of ground truth query-target entity pairs is assigned with a label indicating a type of match between a query entity and a target entity of the respective ground truth query-target entity pair.

12. The non-transitory computer-readable storage medium of claim 8, wherein the label indicates a type of match for respective filtered query-target entity pairs.

13. The non-transitory computer-readable storage medium of claim 8, wherein operations further comprise:
storing the set of filtered query-target entity pairs in a file structure comprising a set of dictionaries, each dictionary recording a respective sub-set of filtered query-target entity pairs as a batch; and
during inference, reading filtered query-target entity pairs from the file structure for processing by the ML model.

14. The non-transitory computer-readable storage medium of claim 13, wherein the file structure further comprises a query key to index map that maps each query entity to a sub-set of filtered query-target entity pairs, and a target index to key map that maps indices of target entities determined from the sub-sets of filtered query-target entity pairs to respective target keys.

15. A system, comprising:
a computing device; and
a computer-readable storage device coupled to the computing device and having instructions stored thereon which, when executed by the computing device, cause the computing device to perform operations for matching a query entity to one or more target entities using machine learning (ML) models, the operations comprising:
receiving historical data comprising a set of ground truth query-target entity pairs;
determining a filtering threshold based on similarity scores of a validation set of ground truth query-target entity pairs of the historical data, the validation set of ground truth query-target entity pairs being a sub-set of the set of ground truth query-target entity pairs of the historical data;
receiving inference data comprising a set of query entities and a set of target entities, each query entity in the set of query entities to be matched to one or more target entities of the set of target entities;
providing, by an embedding module, a set of query entity embeddings and a set of target entity embeddings;
defining a set of query-target entity pairs, each query-target entity pair comprising a query entity of the set of query entities and a target entity of the set of target entities;
for each query-target entity pair in the set of query-target entity pairs, determining a similarity score;
filtering query-target entity pairs from the set of query-target entity pairs based on respective similarity scores to provide a set of filtered query-target entity pairs, the set of filtered query-target entity pairs having fewer query-target entity pairs than the set of query-target entity pairs; and
executing, by a ML model, inference on each filtered query-target entity pair in the set of filtered query-target entity pairs, during inference, the ML model assigning a label to each filtered query-target entity pair.

16. The system of claim 15, wherein determining the filtering threshold comprises:
determining a similarity score between a query entity and a target entity of respective ground truth query-target entity pairs;
determining a minimum similarity score for each unique query entity in the validation set of ground truth query-target entity pairs to provide a set of minimum similarity scores;
sorting minimum similarity scores in descending order; and
selecting the filtering threshold as a minimum similarity score in the set of similarity score based on a target recall score.

17. The system of claim 15, wherein the embedding model and the ML model are trained using a training set of the historical data.

18. The system of claim 15, wherein each ground truth query-target entity pair in the set of ground truth query-target entity pairs is assigned with a label indicating a type of match between a query entity and a target entity of the respective ground truth query-target entity pair.

19. The system of claim 15, wherein the label indicates a type of match for respective filtered query-target entity pairs.

20. The system of claim 19, wherein operations further comprise:
storing the set of filtered query-target entity pairs in a file structure comprising a set of dictionaries, each dictionary recording a respective sub-set of filtered query-target entity pairs as a batch; and
during inference, reading filtered query-target entity pairs from the file structure for processing by the ML model.
